(19) United States
(12) Patent Application Publication
(10) Pub. No.: US 2023/0177574 A1
(43) Pub. Date: Jun. 8, 2023

(54) INFORMATION PROCESSING DEVICE, INFORMATION PROCESSING SYSTEM, AND CONTROL METHOD

(71) Applicant: TOSHIBA TEC KABUSHIKI KAISHA, Tokyo (JP)

(72) Inventors: Tetsuya NOBUOKA, Mishima Shizuoka (JP); Yuishi TAKENO, Numazu Shizuoka (JP)

(21) Appl. No.: 17/960,749

(22) Filed: Oct. 5, 2022

(30) Foreign Application Priority Data
Dec. 7, 2021 (JP) 2021-198417

(51) Int. Cl. G06Q 30/06

(52) U.S. Cl. CPC G06Q 30/0601

(57) ABSTRACT

According to one embodiment, an information processing device includes a processor that is configured to specify a store based on position information for a user and acquire commodity identification information for identifying a commodity to be purchased at the store. The processor also acquires an image of a discount symbol on the commodity. The discount symbol is related to a discount on the commodity at the store. The discount symbol may be affixed to the commodity as a sticker, seal, or the like in some examples. The processor performs image analysis on the image based on analysis settings specific to the store to acquire information related to the discount for the commodity. The processor then registers the commodity in a sales transaction based on the commodity identification information and the information related to the discount.

### CROSS-REFERENCE TO RELATED APPLICATION

This application is based upon and claims the benefit of priority from Japanese Patent Application No. 2021-198417, filed Dec. 7, 2021, the entire contents of which are incorporated herein by reference.

### FIELD

Embodiments described herein relate to an information processing device, an information processing system, and a control method.

### BACKGROUND

Retailers, such as supermarkets, offer discount services to customers at every store to promote commodity sales. In some examples, a discount seal or sticker indicating a discount amount or a discount rate unique to the store is attached to a discount target commodity, and the discount target commodity is priced separately from a non-discounted commodity.

Such a retailer may have introduced an information processing system for sales transactions in which the customer operates a mobile terminal, such as a smartphone, by himself/herself to input data related to a commodity to be purchased. For example, the mobile terminal may be used to scan a data code such as a barcode or a two-dimensional code of an item while on a sales floor rather than at a dedicated sales register. When the commodity to be purchased is a discount target commodity, the customer may input the information related to the discount seal attached to the commodity to be purchased into the mobile terminal by himself/herself. In such a case, image recognition may be used to recognize the input discount seal and apply the relevant discount amount or the discount rate corresponding to the discount seal as specified. Therefore, if accuracy of the image recognition is not sufficiently high, there is a concern that an erroneous discount process may be executed. There is thus a demand for a mechanism that can accurately register a commodity that is accompanied by either a service or discount unique to the store.

### BRIEF DESCRIPTION OF THE DRAWINGS

FIG. 1 is a block diagram showing a schematic configuration of an information processing system.

FIG. 2 is a block diagram showing a configuration of a mobile terminal.

FIG. 3 is a schematic diagram showing an example of a memory of commodities to be purchased.

FIG. 4 is a schematic diagram showing an example of an associative table.

FIG. 5 is a block diagram showing a configuration of a management server.

FIG. 6 is a flowchart of a control procedure of a processor in a mobile terminal.

FIG. 7 is a flowchart of a control procedure of a processor in a mobile terminal.

FIG. 8 is a flowchart of control procedure of a processor in a management server.

FIG. 9 is a flowchart of control procedure of a processor in a management server.

FIG. 10 is a flowchart of control procedure of a processor in a management server.

FIG. 11 is a flowchart of control procedure of a processor in a management server.

FIG. 12 is a flowchart of control procedure of a processor in a management server.

FIG. 13 is a schematic diagram showing an example of a registration screen.

FIG. 14 is a schematic diagram showing an example of a store selection screen.

### DETAILED DESCRIPTION

In general, according to one embodiment, an information processing device, an information processing system, and a control method that can accurately register a commodity accompanied by a service or discount unique to a store are provided.

In one embodiment, an information processing device includes a processor configured to: specify a store based on position information for a user; acquire commodity identification information for identifying a commodity to be purchased at the store; acquire an image of a discount symbol on the commodity, the discount symbol being related to a discount at the store for the commodity; execute analysis (image analysis) on the image based on analysis settings specific to the store to acquire information related to the discount for the commodity; and register the commodity in a sales transaction based on the commodity identification information and the information related to the discount.

Hereinafter, certain example embodiments will be described with reference to the drawings.

In the present embodiment, an information processing system in which a customer operates a mobile terminal by himself/herself to input data related to a commodity to be purchased while on a sales floor is described.

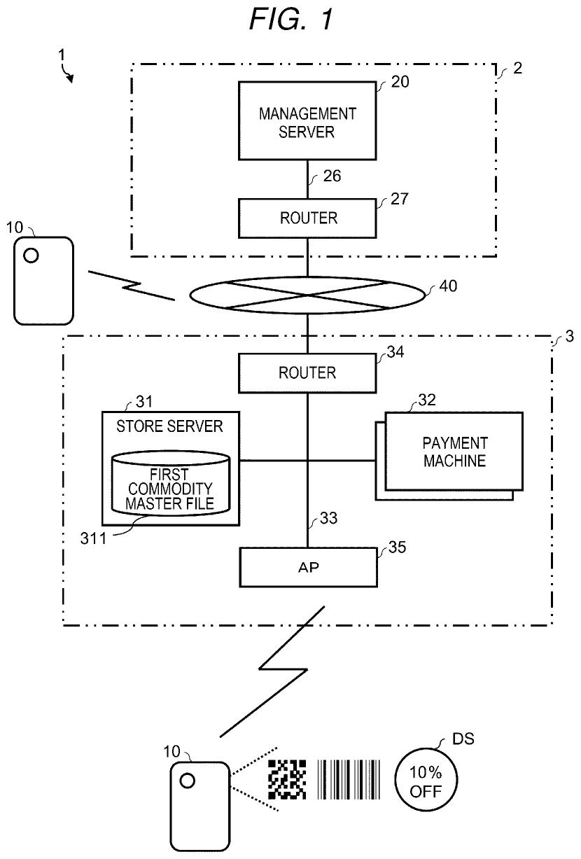

FIG. 1 is a block diagram showing a schematic configuration of an information processing system 1. The information processing system 1 includes a management system 2 and a store system 3, which is constructed in a member store. The management system 2 and the store system 3 can perform bidirectional data communication through a network 40 using an Internet protocol. The network 40 is a wide-area network in which a public line or a dedicated line is used as a relay network and a wired local area network (LAN), a wireless LAN, a mobile communication network, a mobile phone communication network, or the like is used as an access network. Therefore, a mobile terminal 10 using the mobile phone communication network can access the management system 2 via the network 40.

A member store is a store that has a usage contract with a management company of the management system 2. FIG. 1 shows a store system 3 of just one member store. Needless to say, store systems of other member stores can also be connected to the network 40. However, the store systems of other member stores do not necessarily have the same configuration as the store system 3 in FIG. 1. A part of a configuration of the store system may be different depending on the member store. Hereinafter, the member store will be referred to as a store.

The mobile terminal 10 can be used by the customer himself/herself to input data related to the commodity to be purchased. The customer is an example of a user. The mobile terminal 10 is a portable communication terminal. The mobile terminal 10 is, for example, a smartphone or a tablet terminal equipped with a digital camera, which is carried by the customer. The mobile terminal 10 is an example of an information processing device. In some examples, a mobile terminal 10 may be installed on a shopping cart. The mobile terminal 10 includes at least the hardware for reading a data code (such as a bar code or a two-dimensional code) and a discount seal DS. The discount seal DS is attached to a discount target commodity sold at the store to indicate discount information or the like. A discount target commodity might be a commodity whose expiration date or best-by date is approaching. The discount information is, for example, a discount amount or a discount rate (e.g., the percentage off of undiscounted price). The discount information is an example of information related to a discount of a commodity to be purchased.

In the management system 2, a management server 20 is connected to a communication line 26. In addition, a router 27 is connected to the communication line 26, and the management system 2 is connected to the network 40 via the router 27.

The management server 20 manages information related to a store in which the store system 3 of the information processing system 1 is installed.

The store system 3 includes a store server 31 and at least one payment machine 32. The store server 31 and the payment machine(s) 32 are connected to each other via an in-store network 33. In addition, a router 34 is connected to the in-store network 33, and the store system 3 is connected to the network 40 via the router 34. Further, an access point 35 is connected to the in-store network 33, and the store system 3 can perform data communication with the mobile terminal 10 through the wireless LAN via the access point 35.

The store server 31 supports general operations in the store in which the store system 3 is installed.

The store server 31 includes a first commodity master file 311. The first commodity master file 311 stores a commodity data record for the commodities being sold at the store. The commodity data record includes items such as a commodity code, a commodity name, and a price for every store code. The store code is store identification information set for every store in order to individually identify every store. The commodity code is commodity identification information set for every commodity in order to individually identify the commodity. Usually, a barcode indicating the commodity code is attached to every commodity.

The payment machine 32 is a device that enables a clerk or a customer to perform payment for the commodity to be purchased. The number of payment machines 32 is not particularly limited. The payment machine 32 can be a dedicated settlement device that enables the customer to execute by himself/herself the settlement process accompanying payment of the items to be purchased which were previously registered by the customer with the mobile terminal 10. In some examples, the in-store network 33 may be connected to a conventional point of sales (POS) terminal that allows the clerk to execute a registration operation and a settlement operation of the commodity to be purchased, or a registration machine and/or a payment machine that are semi-self-service. In some examples, the registration machine and the payment machine are separated from each other, and the clerk executes the registration operation at the registration machine, and the customer executes the settlement operation at the payment machine by himself/herself.

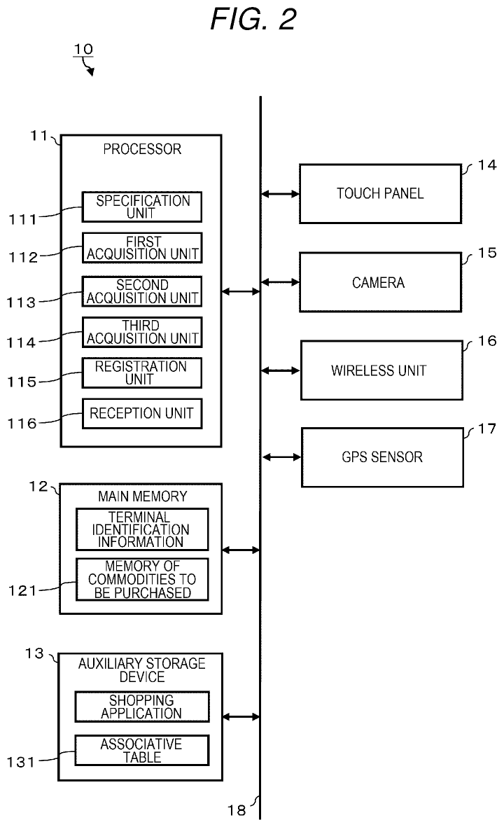

FIG. 2 is a block diagram showing a configuration of the mobile terminal 10. As shown in FIG. 2, the mobile terminal 10 includes a processor 11, a main memory 12, an auxiliary storage device 13, a touch panel 14, a camera 15, a wireless unit 16, a global positioning system (GPS) sensor 17, and a system transmission path 18. The system transmission path 18 includes an address bus, a data bus, a control signal line, and the like. In the mobile terminal 10, the processor 11, the main memory 12, the auxiliary storage device 13, the touch panel 14, the camera 15, the wireless unit 16, and the GPS sensor 17 are connected to the system transmission path 18. The processor 11, the main memory 12, and the auxiliary storage device 13 are connected to each other via the system transmission path 18 to perform information processing for controlling the mobile terminal 10.

The processor 11 controls all described units to implement various functions as the mobile terminal 10 according to an operating system or an application program. The processor 11 is, for example, a central processing unit (CPU).

The main memory 12 includes a non-volatile memory region and a volatile memory region. The main memory 12 stores the operating system or the application program in the non-volatile memory region. The main memory 12 stores data necessary for the processor 11 to execute a process for controlling all units in the volatile memory region. In addition, the main memory 12 uses the volatile memory region as a work area where data is appropriately rewritten by the processor 11. The non-volatile memory region is, for example, a read only memory (ROM). The volatile memory region is, for example, a random access memory (RAM).

For example, an electric erasable programmable read-only memory (EEPROM®), a hard disc drive (HDD), or a solid-state drive (SSD) can be used as the auxiliary storage device 13. The auxiliary storage device 13 stores data used when the processor 11 executes various types of processes, data created by the process in the processor 11, and the like. The auxiliary storage device 13 may store the above-described application program. The auxiliary storage device 13 is an example of a storage unit.

The application program stored in the auxiliary storage device 13 includes a shopping application program. Hereinafter, the shopping application program is referred to as a shopping application of “shopping app”. The shopping application is executed when shopping at the store in which the store system 3 is constructed. A method for installing the shopping application in the auxiliary storage device 13 is not particularly limited. The shopping application can be installed in the auxiliary storage device 13 by recording a control program in a removable recording medium or distributing the control program by communication via a network. The form of the recording medium is not limited as long as the recording medium can store a program and can be read by the device, such as a CD-ROM or a memory card. Instead of the auxiliary storage device 13, the shopping application may be installed in the main memory 12.

For example, a customer who wants to use a smartphone as the mobile terminal 10 installs the shopping application in the smartphone. Then, the customer can use the smartphone as the mobile terminal 10 by executing a user registration.

The touch panel 14 is a device incorporating both an input device and a display device of the mobile terminal 10. The touch panel 14 detects a touch position on the displayed image and outputs touch position information to the processor 11.

The camera 15 is an imaging device built in the mobile terminal 10. The camera 15 operates as an imaging device for a still image or a moving image or as a scanning device for data code such as a barcode or a two-dimensional code in conjunction with the shopping application installed in the mobile terminal 10. The still image includes therein, for example, the discount seal DS.

The wireless unit 16 performs wireless communication of data with the access point 35 according to a wireless communication protocol.

The GPS sensor 17 measures a current position (e.g., latitude and longitude) of the mobile terminal 10 by using the GPS.

The mobile terminal 10 stores terminal identification information in the non-volatile memory region in the main memory 12. The terminal identification information is uniquely set for every mobile terminal 10 in order to individually identify every mobile terminal 10. For example, a program ID of the shopping application installed in the mobile terminal 10 is used as the terminal identification information.

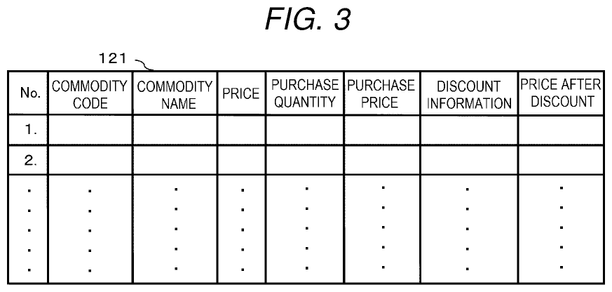

The mobile terminal 10 uses a part of the volatile memory region in the main memory 12 as a region for a memory of commodities to be purchased 121 (see FIG. 3) (e.g., a list of items registered to be purchased). The memory of commodities to be purchased 121 will also be referred to as the registered list 121 in the following. A storage destination of the registered list 121 is not limited to the main memory 12. The registered list 121 may be stored in the auxiliary storage device 13.

FIG. 3 is a schematic diagram showing an example of the registered list 121. The registered list 121 stores information about the items that have been registered for purchase. As shown in FIG. 3, the information about a commodity to be purchased includes a commodity code, a commodity name, a price, a purchase quantity, a purchase price, discount information, and a price after discount for each commodity input (registered) via the mobile terminal 10. The registered items are listed in the order of input (e.g., “No.” column value is an increasing series of numbers). The purchase quantity is the number of the commodities to be purchased identified by the same commodity code, and the purchase price is the sum of the prices based on the purchase quantity. The price after discount is a price of the commodity after the discount is applied. The price after discount is usually cheaper than the price of the commodity before the discount is applied. The registered list 121 is created for every mobile terminal 10.

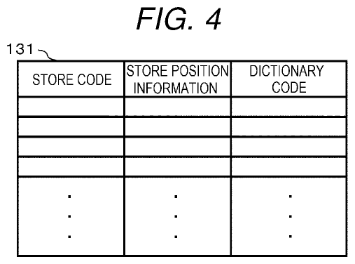

The mobile terminal 10 stores an associative table 131 (see FIG. 4) in the auxiliary storage device 13. The associative table 131 may also or instead be stored in, for example, a memory of an external device with which the mobile terminal 10 can perform communication. The associative table 131 may be provided, for example, in a memory of a server device that can perform communication via the network 40.

FIG. 4 is a schematic diagram showing an example of the associative table 131. As shown in FIG. 4, the associative table 131 is a data table in which a store code, store position information, and a dictionary code are recoded. The store position information is information indicating a position in a store. The store position information may be, for example, two-dimensional coordinate data including an X-axis and a Y-axis. For example, any one place can be set as a reference position, and the reference position is set as an origin O (0, 0) of the two-dimensional coordinates. Then, a plurality of preset positions corresponding, for example, to positional ranges within the store may be represented by two-dimensional coordinates with respect to the origin O. That is, the store position information provides two-dimensional coordinate data. The dictionary code is unique identification information identified by the store code and the store position information that are in the same row.

Referring back to FIG. 2.

The processor 11 functions as a specification unit 111, a first acquisition unit 112, a second acquisition unit 113, a third acquisition unit 114, a registration unit 115, and a reception unit 116. That is, these described units can also be referred to as functions.

The specification unit 111 has three functions. A first function is a function of specifying, based on position information of the user, the store in which the user is located when purchasing a commodity. A second function is a function of specifying the store as the store in which the user purchases the commodity to be purchased when the position information of the user is within a range of position information of a store stored in a storage unit. A third function is a function of specifying the store based on position information associated with an input received by the reception unit 116. The reception unit 116 will be described later.

The first acquisition unit 112 functions to acquire commodity identification information for identifying the commodity to be purchased.

The second acquisition unit 113 functions to acquire an image related to the discount of the commodity to be purchased associated with the store.

The third acquisition unit 114 has two functions. A first function is executing, on the image, an analysis set for the store and acquiring information related to the discount of the commodity to be purchased. A second function is executing an analysis on the image based on a data file set for the store specified by the specification unit 111 among data files related to an analysis on an image related to the discount set for every store, and acquiring information related to the discount of the commodity to be purchased.

The registration unit 115 functions to register the commodity to be purchased based on the commodity identification information and the information related to the discount of the commodity to be purchased.

The reception unit 116 functions to receive an input from the store at which the user purchases the commodity.

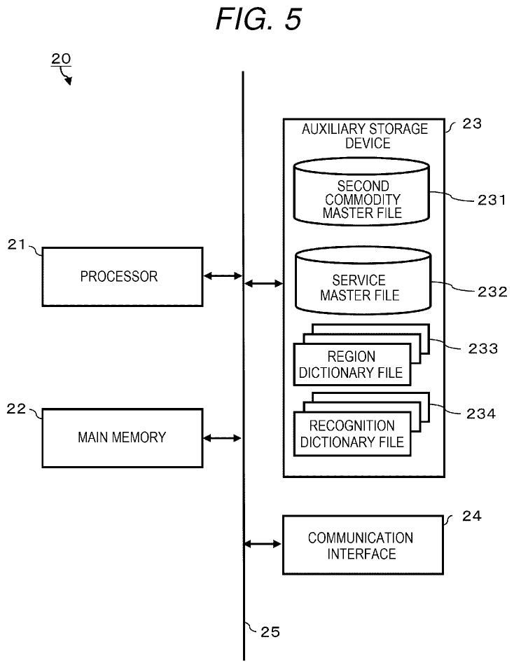

FIG. 5 is a block diagram showing a configuration of the management server 20. The management server 20 includes a processor 21, a main memory 22, an auxiliary storage device 23, a communication interface 24, and a system transmission path 25. The system transmission path 25 includes an address bus, a data bus, a control signal line, and the like. In the management server 20, the processor 21, the main memory 22, the auxiliary storage device 23, and the communication interface 24 are connected to the system transmission path 25. In the management server 20, the processor 21, the main memory 22, the auxiliary storage device 23, and the system transmission path 25 to which the processor 21, the main memory 22, and the auxiliary storage device 23 are connected can be considered a computer.

The processor 21 controls all units to implement various functions as a management server 20 according to an operating system or the application program. The processor 21 is, for example, a CPU.

The main memory 22 includes a non-volatile memory region and a volatile memory region. The main memory 22 stores the operating system or the application program in the non-volatile memory region. The main memory 22 may store data necessary for the processor 21 to execute a process for controlling all units in the non-volatile or volatile memory region. The main memory 22 uses the volatile memory region as a work area in which data is appropriately rewritten by the processor 21. The non-volatile memory region is, for example, an ROM. The volatile memory region is, for example, an RAM.

For example, an EEPROM, an HDD, or an SSD can be used as the auxiliary storage device 23. The auxiliary storage device 23 stores data used when the processor 21 executes various types of processes, data created by the process in the processor 21, and the like. The auxiliary storage device 23 may store the above-described application program.

The communication interface 24 is connected to the in-store network 33. The communication interface 24 performs data communication with other devices connected via the in-store network 33 according to a communication protocol.

The management server 20 stores a second commodity master file 231, a service master file 232, a region dictionary file 233, and a recognition dictionary file 234 in the auxiliary storage device 23. A dictionary file includes the region dictionary file 233 and the recognition dictionary file 234.

The second commodity master file 231 stores a commodity data record with data of the commodities being sold at every store. The commodity data record includes items such as a commodity code, a commodity name, and a price.

The service master file 232 stores a service data record that records service data related to commodities being sold at every store. The service data record includes items such as discount information and an image of the discount seal DS for every dictionary code. The discount seal DS is set in advance for each store, and the image of the discount seal DS is stored in the service data record. In the present embodiment, it is assumed that the discount target commodity is attached along with a barcode representing the commodity code and the discount seal DS.

The region dictionary file 233 is a data file that stores dictionary information related to an image segmentation method for extracting the discount seal DS attached to the discount target commodity from image data or the like. The region dictionary file 233 is set for every dictionary code. The region dictionary file 233 is an example of a data file related to an analysis on an image related to the discount.

The recognition dictionary file 234 is a data file that stores dictionary information related to an image recognition method for recognizing the extracted discount seal DS. The recognition dictionary file 234 is set for every dictionary code. The recognition dictionary file 234 is an example of the data file related to the image analysis related to the discount.

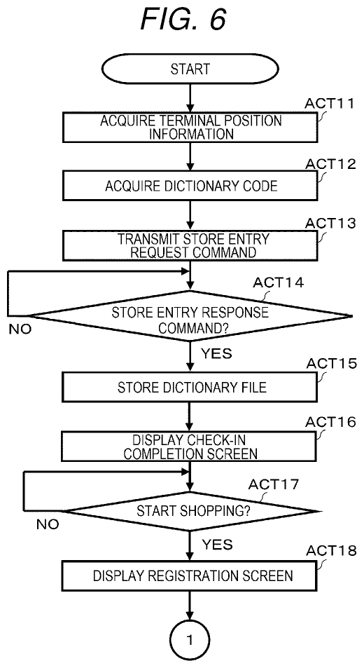

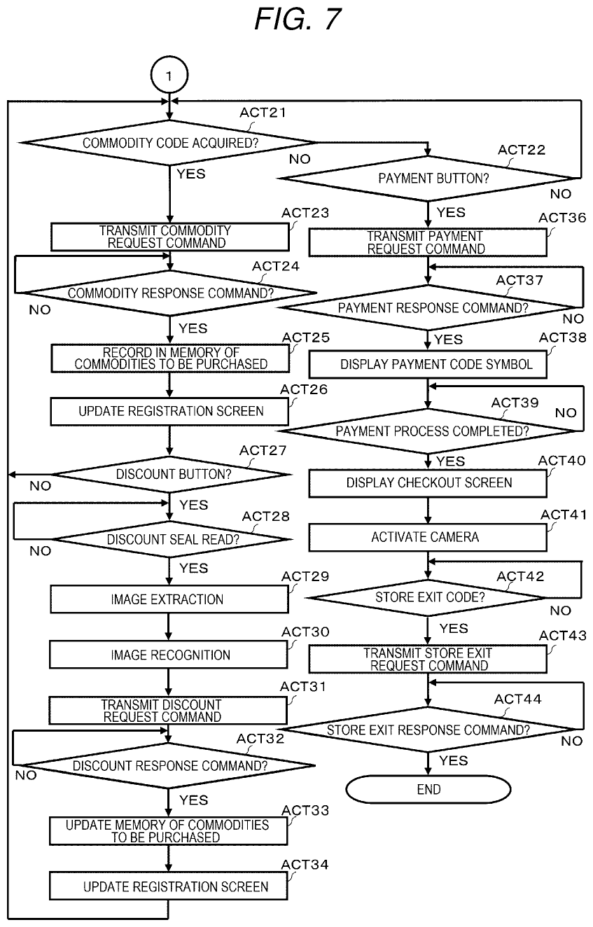

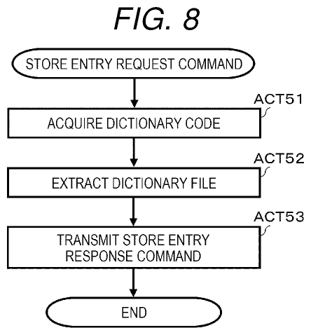

FIGS. 6 and 7 are flowcharts showing aspects of a control procedure executed by the processor 11 of the mobile terminal 10 according to a control method. FIGS. 8 to 12 are flowcharts showing aspects of a control procedure executed by the processor 21 of the management server 20 according to a control method. Hereinafter, certain operations of the information processing system 1 will be described with reference to these drawings, however, the content of the operations described below are only an example. In general, the specifics of the operation procedures and the content thereof are not particularly limited as long as similar results can be achieved.

The customer who carries the mobile terminal 10 activates the shopping application before entering the store. Thus, the processor 11 starts the information processing procedure shown in the flowchart in FIG. 6.

In ACT 11, the processor 11 acquires terminal position information. The terminal position information is information indicating a current position of the mobile terminal 10 as measured by the GPS sensor 17. The terminal position information can be considered information indicating a current position of the customer who carries the mobile terminal 10. The terminal position information is an example of position information. The terminal position information may be, for example, two-dimensional coordinate data including an X-axis and a Y-axis. For example, any one place can be set as a reference position, and the reference position is set as the origin O (0, 0) of X-Y coordinates. Then, the current position of the mobile terminal 10 may be represented by the X-Y coordinates with respect to the origin O.

In ACT 12, the processor 11 refers to the associative table 131, and acquires a dictionary code from the same row as the store position information matching the terminal position information. That is, the processor 11 identifies, based on the terminal position information, by the function of the specification unit 111, a store in which the customer is located. In addition, the processor 11 stores the dictionary code in the main memory 12. The processor 11 may also or instead store the dictionary code in the auxiliary storage device 13.

In ACT 13, the processor 11 transmits a store entry request command to the management server 20 via the network 40. The store entry request command includes the dictionary code.

When the processor 21 of the management server 20 receives the store entry request command from the mobile terminal 10, the processor 21 starts the command reception procedure shown in the flowchart in FIG. 8.

In ACT 51, the processor 21 acquires the dictionary code from the store entry request command.

In ACT 52, the processor 21 extracts the region dictionary file 233 and the recognition dictionary file 234 corresponding to the dictionary code.

In ACT 53, the processor 21 transmits a store entry response command to the mobile terminal 10 via the network 40. The store entry response command includes the region dictionary file 233 and the recognition dictionary file 234. The processor 21 ends the store entry request command reception.

Referring back to FIG. 6.

In ACT 14, the processor 11 of the mobile terminal 10 waits for the store entry response command from the management server 20. When the store entry response command is received from the management server 20, the processor 11 determines YES in ACT 14, and the process proceeds to ACT 15.

In ACT 15, the processor 11 stores, in the main memory 12, the region dictionary file 233 and the recognition dictionary file 234 included in the store entry response command. The processor 11 may also or instead store the region dictionary file 233 and the recognition dictionary file 234 in the auxiliary storage device 13.

In ACT 16, the processor 11 displays a check-in completion screen on the touch panel 14. For example, a message indicating that shopping is ready and an image of a “Yes” button are displayed on the check-in completion screen. The customer presses the “Yes” button after confirming the check-in completion screen.

In ACT 17, the processor 11 waits for an instruction to start shopping. When the customer presses the “Yes” button on the check-in completion screen, the processor 11 determines that the start of shopping is instructed. After the start of shopping is instructed, the processor 11 determines YES in ACT 17, and the process proceeds to ACT 18.

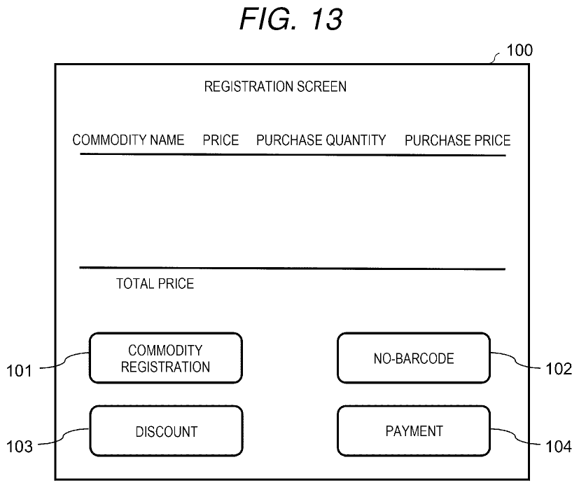

In ACT 18, the processor 11 displays a registration screen 100 on the touch panel 14 (see FIG. 13).

FIG. 13 is a schematic diagram showing an example of the registration screen 100. As shown in FIG. 13, for example, a region for displaying a commodity name, a price, a purchase quantity, a purchase price, and a total price of a registered commodity is formed on the registration screen 100. The total price is a total purchase price. The registration screen 100 includes an image of a commodity registration button 101, an image of a no-barcode button 102, an image of a discount button 103, and an image of a payment button 104.

When registering a commodity to be purchased, the customer presses the commodity registration button 101. When the commodity registration button 101 is pressed, for example, the processor 11 displays a camera screen on the touch panel 14. For example, an image indicating a read region of a barcode attached to the commodity is displayed on the camera screen.

When registering a commodity to be purchased without a barcode, the customer presses the no-barcode button 102. When the no-barcode button 102 is pressed, for example, the processor 11 displays a list of no-barcode commodities on the touch panel 14.

When the commodity to be purchased is a discount target commodity, the customer presses the discount button 103. When the discount button 103 is pressed, for example, the processor 11 displays a camera screen on the touch panel 14. For example, an image indicating a read region of the discount seal DS attached to the commodity to be purchased is displayed on the camera screen. The discount button 103 may be activated, for example, when the customer presses the commodity registration button 101 or the no-barcode button 102 to register the commodity to be purchased.

When payment is instructed, the customer presses the payment button 104. The content and images of text data displayed in FIG. 13 are only examples.

After confirming the registration screen 100, the customer sets the mobile terminal 10 in a shopping cart or carries the mobile terminal 10 and goes around a sales floor where the commodities are displayed. When the customer finds the commodity to be purchased, the customer presses the commodity registration button 101 and causes the camera 15 to read the barcode attached to the commodity to be purchased. The processor 11 acquires the commodity code represented by the barcode.

When no barcode is attached to the commodity to be purchased, the customer presses the no-barcode button 102, and selects the commodity to be purchased from the list of no-barcode commodities. The processor 11 thus acquires the commodity code of the selected commodity to be purchased.

That is, in ACT 21 of FIG. 7, the processor 11 determines whether the commodity code has been acquired. If the commodity code is not acquired, the processor 11 determines NO in ACT 21, and the process proceeds to ACT 22.

In ACT 22, the processor 11 determines whether the payment button 104 is pressed. When the payment button 104 is not pressed, the processor 11 determines NO in ACT 22, and the process proceeds to ACT 21. That is, the processor 11 is in a wait state in ACT 21 to ACT 22.

In the wait state in ACT 21 to ACT 22, when the processor 11 acquires the commodity code by the function of the first acquisition unit 112, the processor 11 determines YES in ACT 21, and the process proceeds to ACT 23.

In ACT 23, the processor 11 transmits a commodity request command to the management server 20 via the network 40. The commodity request command includes the store code stored in the main memory 12 and the commodity code acquired by the process in ACT 21.

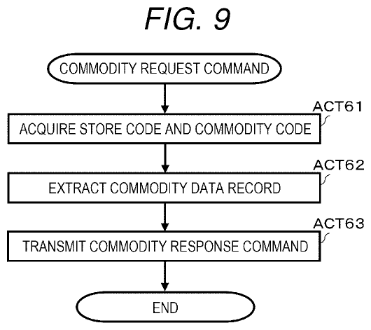

When the processor 21 of the management server 20 receives the commodity request command from the mobile terminal 10, the processor 21 starts the command reception procedure shown in the flowchart in FIG. 9.

In ACT 61, the processor 21 acquires the store code and the commodity code from the commodity request command.

In ACT 62, the processor 21 refers to the second commodity master file 231 corresponding to the store code and extracts the commodity data record including the commodity code found in the commodity request command.

In ACT 63, the processor 21 transmits a commodity response command to the mobile terminal 10 via the network 40. The commodity response command includes the commodity data record extracted in the process in ACT 62. According to the above, the processor 21 ends the commodity request command reception.

Referring back to FIG. 7.

In ACT 24, the processor 11 of the mobile terminal 10 waits for the commodity response command from the management server 20. When the commodity response command is received from the management server 20, the processor 11 determines YES in ACT 24, and the processing proceeds to ACT 25.

In ACT 25, the processor 11 records, in the registered list 121, the commodity data record included in the commodity response command.

In ACT 26, the processor 11 updates the registration screen 100. That is, the processor 11 updates the registration screen 100 such that the commodity name, the price, the purchase quantity, and the purchase price for the commodity to be purchased recorded in the registered list 121 are added, and the purchase price is added to the total price.

In ACT 27, the processor 11 waits for the discount button 103 to be pressed. When the discount button 103 is not pressed, the processor 11 determines NO in ACT 27, and the process proceeds to ACT 21.

When the discount button 103 is pressed, the processor 11 determines YES in ACT 27, and the process proceeds to ACT 28.

In ACT 28, the processor 11 waits for the discount seal DS attached to the commodity being purchased to be read by the camera 15. If the discount seal DS fits within the image indicating the read region, the processor 11 determines that the discount seal DS has been read. That is, the processor 11 acquires an image including the discount seal DS by the function of the second acquisition unit 113. The image including the discount seal DS is an example of the image related to the discount of the commodity to be purchased. The processor 11 determines YES in ACT 28, and the process proceeds to ACT 29.

In ACT 29, the processor 11 extracts an image matching a region of the discount seal DS from the larger image including the discount seal DS by using the dictionary information of the region dictionary file 233. The image segmentation method includes, for example, deep learning using a convolutional neural network (CNN), which is a method suitable for image recognition. As the image segmentation method, graph cuts or the like may be used, but, in general, any known method may be used. The extraction of the image matching a region of the discount seal DS by using the dictionary information of the region dictionary file 233 is an example of the analysis set for the store.

In ACT 30, the processor 11 recognizes, by using the dictionary information of the recognition dictionary file 234, the discount seal DS in the image extracted in ACT 29. The image recognition method includes, for example, deep learning using CNN, which is a method suitable for image recognition. As the image recognition method, optical character recognition (OCR), feature point matching, or the like may be used, but, in general, any known method may be used. The recognition of the discount seal DS by using the dictionary information of the recognition dictionary file 234 is an example of the analysis set for the store.

In ACT 31, the processor 11 transmits a discount request command to the management server 20 via the network 40. The discount request command includes the dictionary code stored in the main memory 12 and an image of the discount seal DS after the processes of ACT 29 and ACT 30.

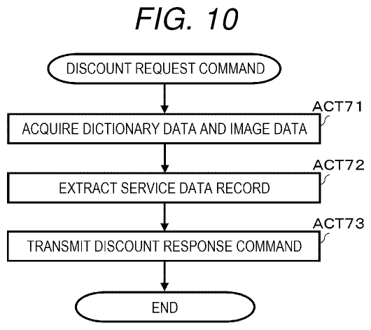

When the processor 21 of the management server 20 receives the discount request command from the mobile terminal 10, the processor 21 starts the command reception procedure shown in the flowchart in FIG. 10.

In ACT 71, the processor 21 acquires the dictionary code and the image of the discount seal DS from the discount request command.

In ACT 72, the processor 21 refers to the service master file 232 corresponding to the dictionary code and extracts the discount information from the service data record including the image of the discount seal DS.

In ACT 73, the processor 21 transmits a discount response command to the mobile terminal 10 via the network 40. The discount response command includes the discount information. According to the above, the processor 21 ends the discount request command reception.

Referring back to FIG. 7.

In ACT 32, the processor 11 of the mobile terminal 10 waits for the discount response command from the management server 20. When the discount response command is received from the management server 20, the processor 11 determines YES in ACT 32, and the process proceeds to ACT 33. That is, the processor 11 acquires the discount information by the function of the third acquisition unit 114.

In ACT 33, the processor 11 updates the registered list 121 by the function of the registration unit 115. That is, the processor 11 updates the registered list 121 such that the discount information included in the discount response command is added to the same row as the last commodity code recorded in the registered list 121, and the price after discount calculated based on the discount information is added.

In ACT 34, the processor 11 updates the registration screen 100. That is, the processor 11 updates the registration screen 100 such that the price of the commodity to be purchased displayed on the registration screen 100 is changed to the price after discount, and the purchase price and the total price are changed based on the price after discount.

Next, the customer who completes shopping on the sales floor presses the payment button 104. In the wait state in ACT 21 to ACT 22, when the payment button 104 is pressed, the processor 11 determines YES in ACT 22, and the process proceeds to ACT 36.

In ACT 36, the processor 11 transmits a payment request command to the management server 20 via the network 40. The payment request command includes the terminal identification information.

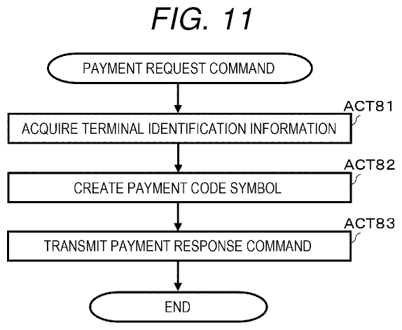

When the processor 21 of the management server 20 receives the payment request command from the mobile terminal 10, the processor 21 starts the command reception procedure shown in the flowchart in FIG. 11.

In ACT 81, the processor 21 acquires the terminal identification information from the payment request command.

In ACT 82, the processor 21 creates a unique payment code symbol. The payment code symbol is for identifying a customer who will perform payment at the payment machine 32. The processor 21 may create, for example, the payment code symbol obtained by barcoding the terminal identification information using a predetermined barcode system.

In ACT 83, the processor 21 transmits a payment response command to the mobile terminal 10 via the network 40. The payment response command includes data of the payment code symbol. According to the above, the processor 21 ends the payment request command reception.

Referring back to FIG. 7.

In ACT 37, the processor 11 of the mobile terminal 10 waits for the payment response command from the management server 20. When the payment response command is received from the management server 20, the processor 11 determines YES in ACT 37, and the process proceeds to ACT 38.

In ACT 38, the processor 11 displays the payment code symbol on the touch panel 14.

The customer moves to the payment machine 32. Then, when the customer uses, for example, a scanner provided in the payment machine 32 to read the payment code symbol, a payment process is started. Since the payment process is well known as an existing process, additional description thereof will be omitted.

In ACT 39, the processor 11 of the mobile terminal 10 waits for a payment process completed command from the payment machine 32. When the payment process completed command is received from the payment machine 32, the processor 11 determines YES in ACT 39, and the process proceeds to ACT 40.

In ACT 40, the processor 11 displays a checkout screen on the touch panel 14. For example, a message instructing to read a store exit code and an image of a “Yes” button for instructing the customer to confirm the message are displayed on the checkout screen. The store exit code is obtained by encoding setting information related to the store in a predetermined two-dimensional code system, and is prepared, for example, at an exit of the store. The setting information includes, for example, the store code. The customer presses the “Yes” button after confirming the checkout screen.

In ACT 41, when the customer presses the “Yes” button on the checkout screen, the processor 11 activates the camera 15. The processor 11 displays a camera screen on the touch panel 14. After confirming the camera screen, the customer holds the lens of the camera 15 over the store exit code such that the store exit code displayed at the exit of the store fits within the image indicating the read region.

In ACT 42, the processor 11 waits for the store exit code to be read by the camera 15. When the store exit code fits within the image indicating the read region, the processor 11 determines that the store exit code has been read. That is, the processor 11 determines YES in ACT 42, and the process proceeds to ACT 43.

In ACT 43, the processor 11 transmits a store exit request command to the management server 20 via the network 40. The store exit request command includes the terminal identification information.

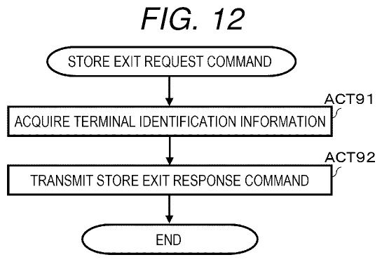

When the processor 21 of the management server 20 receives the store exit request command from the mobile terminal 10, the processor 21 starts the command reception procedure shown in the flowchart in FIG. 12.

In ACT 91, the processor 21 acquires the terminal identification information from the store exit request command.

In ACT 92, the processor 21 transmits a store exit response command to the mobile terminal 10 via the network 40. According to the above, the processor 21 ends the store exit request command reception.

Referring back FIG. 7.

In ACT 44, the processor 11 of the mobile terminal 10 waits for the store exit response command from the management server 20. When the store exit response command is received from the management server 20, the processor 11 determines YES in ACT 44, and the information processing procedures shown in the flowcharts of FIGS. 6 and 7 is ended.

As seen in the above description, when the customer activates the shopping application before entering the store, the processor 11 of the mobile terminal 10 acquires the terminal position information. The processor 11 refers to the associative table 131, acquires a dictionary code in the same row as the store position information matching the terminal position information, and transmits the store entry request command to the management server 20.

Accordingly, it is not necessary for the customer to input, on the mobile terminal 10, any operation for specifying a store at which the customer goes for shopping, and the time and effort of the customer can be saved.

Upon receiving the store entry request command, the management server 20 extracts the region dictionary file 233 and the recognition dictionary file 234 corresponding to the dictionary code and transmits the store entry response command to the mobile terminal 10. The processor 11 stores, in the main memory 12, the region dictionary file 233 and the recognition dictionary file 234 included in the store entry response command. Thereafter, when the barcode attached to a commodity to be purchased is read by the camera 15, the processor 11 acquires the commodity code and transmits the commodity request command to the management server 20. Upon receiving the commodity request command, the management server 20 refers to the second commodity master file 231 corresponding to the store code, extracts the commodity data record for the commodity code, and transmits the commodity response command to the mobile terminal 10. If the commodity to be purchased is a discount target commodity, and a discount seal DS attached to the commodity to be purchased is read by the camera 15, the processor 11 performs image extraction and image recognition on the image including the discount seal DS by using the region dictionary file 233 and the recognition dictionary file 234. The processor 11 transmits the discount request command including the processed image of the discount seal DS to the management server 20.

Accordingly, the processor 11 only needs to execute an analysis set specifically for the store on the discount seal DS unique to the store, and does not need to execute analysis for every possible store. Therefore, a process load of the processor 11 can be reduced. Furthermore, since the processor 11 uses the data file set for the store specifically, that is, the region dictionary file 233 and the recognition dictionary file 234 for the analysis of the discount seal DS, it is possible to more accurately recognize the particular discount seals DS unique (or substantially so) to the store.

Upon receiving the discount request command, the management server 20 refers to the service master file 232 corresponding to the dictionary code, extracts the discount information from the service data record including the image of the discount seal DS, and transmits the discount response command to the mobile terminal 10. The processor 11 updates the registered list 121 and the registration screen 100 based on the discount information included in the discount response command.

Accordingly, since the processor 11 acquires the discount information based on an accurately recognized discount seal DS, it is possible to prevent an erroneous discount process.

In an embodiment, a barcode representing the commodity code is described as usually being attached to every commodity. In other examples, a two-dimensional code other than a barcode may be used for representing the commodity code.

In an embodiment, the mobile terminal 10 is described to include the GPS sensor 17. In addition, the terminal position information is described as information indicating the current position of the mobile terminal 10 as measured by the GPS sensor 17. In other examples, a beacon terminal may be disposed at the entrance or the like of the store, and the current position of the mobile terminal 10 may be acquired in combination with the smartphone or the like carried by the customer.

In an embodiment, the processor 11 is described to acquire the terminal position information, refer to the associative table 131, and acquire the dictionary code from the same row as the store position information matching the terminal position information. In other examples, the processor 11 may acquire the store code from a store entry code placed at the entrance of the store, refer to the associative table 131, and acquire the dictionary code in the same row as the store code.

For example, in such a case, when the customer activates the shopping application before entering the store, the processor 11 displays a check-in screen on the touch panel 14, a message instructing to read the store entry code and an image of a “Yes” button for instructing the customer to confirm the message may be displayed on the check-in screen. The store entry code is obtained by encoding setting information related to the store in a predetermined two-dimensional code system. The setting information includes, for example, the store code. The customer presses the “Yes” button after confirming the check-in screen. When the customer presses the “Yes” button on the check-in screen, the processor 11 activates the camera 15. The processor 11 displays a camera screen on the touch panel 14. After confirming the camera screen, the customer holds the lens of the camera 15 over the store entry code such that the store entry code fits within the image indicating the read region. When the store entry code fits within the image indicating the read region, the processor 11 determines that the store entry code has been read. The processor 11 stores, in the main memory 12 or the auxiliary storage device 13, the store code as acquired from the store entry code. Then, the processor 11 may refer to the associative table 131 and acquire the dictionary code in the same row as the store code. The store code obtained from the store entry code is thus also an example of position information.

For example, when the processor 11 acquires the store code from the store entry code after acquiring the terminal position information, the processor 11 may determine whether the acquired terminal position information is within a range of the store position information recorded in the same row as the store code stored in the main memory 12 or the auxiliary storage device 13.

When the terminal position information is not within the range of the shop position information, the processor 11 may notify an error. In this case, the processor 11 displays an error screen on the touch panel 14, for example. For example, a message notifying that the store at which the customer is shopping cannot be identified based on the current position of the customer and an image of a “Yes” button for instructing the customer to confirm the message are displayed on the error screen. In some examples, the processor 11 may output by a voice that the store in which the customer goes for shopping cannot be specified based on the current position of the customer.

When the terminal position information is within the range of the store position information, the processor 11 may specify, by the function of the specification unit 111, the store at which the customer purchases the commodity to be purchased.

Accordingly, the store at which the customer goes for shopping can be reliably specified.

In an embodiment, the store exit code is described as being obtained by an encoding by the predetermined two-dimensional code system. In other examples, the store exit code may be generated in a one-dimensional code system. Similarly, a store entry code may be a one-dimensional code.

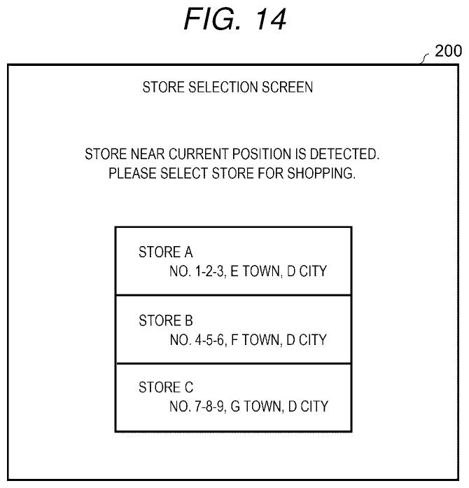

In an embodiment, the processor 11 is described as acquiring the terminal position information by the GPS sensor 17 in ACT 11 in FIG. 6. In other examples, the processor 11 may display a store selection screen 200 on the touch panel 14 (see FIG. 14) when the customer activates the shopping application before entering the store.

FIG. 14 is a schematic diagram showing an example of the store selection screen 200. As shown in FIG. 14, a message notifying the customer that multiple stores near the current position of the mobile terminal 10 have been detected and instructing the customer to select a store for shopping is displayed on the store selection screen 200. On the store selection screen 200, for example, a store name, a store address, and the like are displayed as a list. The content and images of text data displayed in FIG. 14 are only examples.

When, the customer selects the store, the processor 11 accepts the input by the function of the reception unit 116. The processor 11 refers to a store table and acquires the store code corresponding to the store name and the store address. The store table is, for example, a data table in which the store code, the store name, and the store address are recorded. The store address is an example of position information. The processor 11 stores the store table in the main memory 12 or the auxiliary storage device 13. When the store code acquired from the store entry code matches the store code acquired based on the store selection screen 200, the processor 11 may acquire, from the associative table 131, a dictionary code in the same row as the store code. That is, the processor 11 specifies, by the function of the specification unit 111, a store based on position information associated with the input on the store selection screen 200.

Accordingly, even when the current position of the mobile terminal 10 cannot be accurately acquired due to the failure of the GPS sensor 17, it is possible to reliably specify, based on the store selected on the store selection screen 200, the store at which the customer goes for shopping.

In an embodiment, the associative table 131 is described as the data table in which the store code, the store position information, and the dictionary code are recorded. In some examples, the associative table 131 may not include the store code.

In an embodiment, the region for displaying the commodity name, the price, the purchase quantity, the purchase price, and the total price for the registered commodity is described to be formed on the registration screen 100. In some examples, a cancel button corresponding to the commodity name, the price, the purchase quantity, and the purchase price may be further displayed in this region. When the commodity registration of the commodity to be purchased is to be canceled, the customer presses the cancel button. When the cancel button is pressed, the processor 11 may cancel/remove, from the registered list 121, the registration information of the commodity corresponding to the selected cancel button. For example, the processor 11 may display on the registration screen 100 a cancellation line (strikethrough) on the commodity name, the price, the purchase quantity, and the purchase price for the canceled commodity or may erase the commodity name, the price, the purchase quantity, and the purchase price from the registration screen 100.

In an embodiment, the registration screen 100 is described to include an image of the discount button 103. In other examples, the registration screen 100 need not include an image of the discount button 103. For example, when the processor 11 acquires the commodity code, a camera screen may be displayed on the touch panel 14. For example, the image indicating the read region of the discount seal DS attached to the commodity to be purchased is displayed on the camera screen. In this case, ACT 27 in FIG. 7 is omitted. In addition, the camera screen may include a registration screen button. When the commodity to be purchased is not a discount target commodity, the customer presses the registration screen button. When the registration screen button is pressed, for example, the processor 11 displays the registration screen 100 on the touch panel 14.

In an embodiment, the service data record is described to include items such as the discount information and the image of the discount seal DS. In other examples, the service data record may further include items such as the commodity code, a price before discount, and the price after discount. The price before discount is a price of the commodity before the discount is applied. In this case, in ACT 72 in FIG. 10, the processor 21 of the management server 20 refers to the service master file 232 corresponding to the dictionary code, and extracts the commodity code, the discount information, and the price after discount from the service data record including the image of the discount seal DS. In ACT 73, the processor 21 transmits the discount response command to the mobile terminal 10 via the network 40. The discount response command includes, for example, the commodity code, the discount information, and the price after discount. In ACT 33 in FIG. 7, upon receiving the discount response command from the management server 20, the processor 11 of the mobile terminal 10 may refer to the registered list 121 and add the discount information and the price after discount included in the discount response command to the same row as the commodity code included in the discount response command.

In an embodiment, the registration information of the commodity to be purchased stored in the registered list 121 is described to include the price after discount. In other examples, the registered information about the commodity to be purchased may not include the price after discount. In this case, in ACT 33 in FIG. 7, for example, the processor 11 may refer to the registered list 121 and update a price recorded in the same row as the commodity code recorded in the last row of the registered list 121 to the price after discount, which is calculated based on the discount information included in the discount response command.

In an embodiment, it is described that when the processor 21 of the management server 20 receives the store entry request command including the dictionary code from the mobile terminal 10, the processor 21 extracts the region dictionary file 233 and the recognition dictionary file 234 corresponding to the dictionary code, and transmits the store entry response command including the region dictionary file 233 and the recognition dictionary file 234 to the mobile terminal 10. In some examples, the processor 21 may further extract the service master file 232 corresponding to the dictionary code and transmit a store entry response command including the region dictionary file 233, the recognition dictionary file 234, and the service master file 232 to the mobile terminal 10. Upon receiving the store entry response command, the processor 11 stores, in the main memory 12, the region dictionary file 233, the recognition dictionary file 234, and the service master file 232 included in the store entry response command. In this case, ACT 31 and ACT 32 in FIG. 7 are omitted. The processor 11 of the mobile terminal 10 executes ACT 72 in FIG. 10. In this case, the service master file 232 is an example of the data file related to the analysis on the image related to the discount. The reference to the service master file 232 corresponding to the dictionary code is an example of the analysis set for the store. The analysis set for the store may include all of the extraction of the image indicating the region of the discount seal DS by using the dictionary information of the region dictionary file 233, the recognition of the discount seal DS by using the dictionary information of the recognition dictionary file 234, and the reference to the service master file 232 corresponding to the dictionary code, or may include any one thereof, or may include a sub-combination thereof.

In an embodiment, the mobile terminal 10 is described as using a part of the volatile memory region in the main memory 12 for the registered list 121 and the auxiliary storage device 13 for the associative table 131. In other examples, a part of the volatile memory region in the main memory 22 of the management server 20 may be used as the region of the registered list 121, and the associative table 131 may be stored in the auxiliary storage device 23. That is, the management system 2 may provide some of the described functions of the mobile terminal 10. In this case, the management server 20 is an example of an information processing device. The second acquisition unit 113 thus functions to acquire, from the mobile terminal 10 carried by the user, the image related to the discount of the commodity to be purchased associated with the store via the network 40. The auxiliary storage device 23 of the management server 20 is an example of a storage unit. The analysis set for the store may include all of the extraction of the image indicating the region of the discount seal DS by using the dictionary information of the region dictionary file 233, the recognition of the discount seal DS by using the dictionary information of the recognition dictionary file 234, and the reference to the service master file 232 corresponding to the dictionary code, or may include any one thereof, or may include a sub-combination thereof.

In an embodiment, the management server 20 stores the second commodity master file 231, the service master file 232, the region dictionary file 233, and the recognition dictionary file 234 in the auxiliary storage device 23. In other examples, the auxiliary storage device 13 of the mobile terminal 10 may be used to store the second commodity master file 231, the service master file 232, the region dictionary file 233, and the recognition dictionary file 234. That is, the mobile terminal 10 may provide certain described functions of the management system 2. The analysis set for the store may include all of the extraction of the image indicating the region of the discount seal DS by using the dictionary information of the region dictionary file 233, the recognition of the discount seal DS by using the dictionary information of the recognition dictionary file 234, and the reference to the service master file 232 corresponding to the dictionary code, or may include any one thereof, or may include a sub-combination thereof.

An embodiment describes a case in which the payment machine 32 is a device that enables the clerk or the customer to perform payment on the commodity to be purchased. In some examples, the payment for the commodity to be purchased may be made by online settlement or the like. The online settlement can be settlement process executed by the mobile terminal 10 in cooperation with another electronic device (e.g., an electronic payment server) via the Internet or the like. The online settlement corresponds to a cashless settlement. In this case, the payment machine 32 is not specifically required.

The information processing device may be implemented as a single device, or may be implemented as a system in which functions are distributed across a plurality of devices.

While certain embodiments have been described, these embodiments have been presented by way of example only, and are not intended to limit the scope of the inventions. Indeed, the novel embodiments described herein may be embodied in a variety of other forms; furthermore, various omissions, substitutions, and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device, comprising:
a processor configured to:
specify a store based on position information for a user;
acquire commodity identification information for identifying a commodity to be purchased at the store;
acquire an image of a discount symbol on the commodity, the discount symbol being related to a discount at the store for the commodity;
execute analysis on the image based on analysis settings specific to the store to acquire information related to the discount for the commodity; and
register the commodity in a sales transaction based on the commodity identification information and the information related to the discount.

2. The information processing device according to claim 1, further comprising:
a communication interface, wherein
the analysis settings are retrieved from a server apparatus via the communication interface based on identification information for the specified store.

3. The information processing device according to claim 1, wherein the position information for the user is supplied via the communication interface from a beacon terminal at the store.

4. The information processing device according to claim 1, further comprising:
a position sensor, wherein
the position sensor is configured to provide the position information for the user.

5. The information processing device according to claim 4, wherein the position sensor is a global positioning system (GPS) sensor.

6. The information processing device according to claim 4, wherein the processor is further configured to display a store selection screen on a display of the information processing device when more than one store is identified as being within a predetermined range of the position information.

7. The information processing device according to claim 1, further comprising:
a camera, wherein
the image of the discount symbol is acquired with the camera.

8. An information processing system, comprising:
a mobile terminal including a first processor configured to:
specify a store based on position information for a user;
acquire commodity identification information for identifying a commodity to be purchased at the store;
acquire an image of a discount symbol on the commodity, the discount symbol being related to a discount at the store for the commodity;
execute analysis on the image based on analysis settings specific to the store to acquire information related to the discount for the commodity; and
register the commodity in a sales transaction based on the commodity identification information and the information related to the discount.

9. The information processing system according to claim 8, further comprising:
a first server apparatus including a second processor and a storage device, wherein
the analysis settings specific to the store are stored in the storage device and supplied to the mobile terminal based on the position information.

10. The information processing system according to claim 9, further comprising:
a second server apparatus, wherein
the second server stores commodity information in association with commodity identification information.

11. The information processing system according to claim 8, wherein
the mobile terminal further comprises:
a communication interface, and
the analysis settings are retrieved from a server apparatus via the communication interface based on identification information for the specified store.

12. The information processing system according to claim 8, wherein the position information for the user is supplied via the communication interface from a beacon terminal at the store.

13. The information processing system according to claim 8, wherein
the mobile terminal further comprises:
a position sensor, wherein
the position sensor is configured to provide the position information for the user.

14. The information processing system according to claim 13, wherein the position sensor is a global positioning system (GPS) sensor.

15. The information processing system according to claim 13, wherein the first processor is further configured to display a store selection screen on a display of the information processing device when more than one store is identified as being within a predetermined range of the position information.

16. The information processing system according to claim 8, wherein
the mobile terminal further comprises:
a camera, and
the image of the discount symbol is acquired with the camera.

17. A method for an information processing device to acquire commodity discount information for a retail sales transaction, the method comprising:
specifying a store based on position information for a user;
acquiring commodity identification information for identifying a commodity to be purchased at the store;
acquiring an image of a discount symbol on the commodity, the discount symbol being related to a discount at the store for the commodity;
executing analysis on the image based on analysis settings specific to the store to acquire information related to the discount for the commodity; and
registering the commodity in a sales transaction based on the commodity identification information and the information related to the discount.

18. The method according to claim 17, wherein the discount symbol is a sticker affixed to the commodity.

19. The method according to claim 17, wherein the discount symbol is store-specific.

20. The method according to claim 17, wherein the analysis settings are retrieved from a server apparatus via a communication interface based on identification information for the specified store.
